(19) United States
(12) Patent Application Publication
(10) Pub. No.: US 2015/0314461 A1
(43) Pub. Date: Nov. 5, 2015

(54) Hybrid Shaving System

(71) Applicant: Raymond Industrial Ltd., Shatin (CN)

(72) Inventors: John Ying Man Wong, Shatin (HK); Anthony Kowk Yung Law, Tai Po (HK)

(73) Assignee: Raymond Industrial Ltd., Shatin (CN)

(21) Appl. No.: 14/268,808

(22) Filed: May 2, 2014

(51) Int. Cl. B26B 19/38; B26B 19/06; B26B 19/04

(52) U.S. Cl. CPC B26B 19/384; B26B 19/046; B26B 19/06

(57) ABSTRACT

A cutter for an electric shaver includes an inner cutter having a plurality of inner cutter ribs. Each inner cutter rib may be orientated at a first angle. A frame may be coupled to the inner cutter. An outer cutter may be coupled to the frame and may include a comb portion. The comb portion may include a plurality of outer cutter ribs with each outer cutter rib including a first and second chamfer and a contour disposed therebetween. The contour may gradually slope inwardly from the first and second chamfer to a substantially flat central surface. Each outer cutter rib may be orientated at a second angle that correspondingly oppositely-faces the first angle. The plurality of inner cutter ribs is in operable engagement with the plurality of outer cutter ribs.

### TECHNICAL FIELD

The present disclosure relates generally to electric shavers and, more particularly, to cutting heads.

### BACKGROUND

Electric shavers generally utilize one of two cutting systems, namely, foil systems and rotary systems. The foil systems typically include a thin metallic cutting foil, which is in close surface contact with an oscillating cutter. The cutting foil has many small perforations so that, during a shaving pass, the user's hairs extrude through the perforations and are cut by the reciprocating movement of the oscillating cutter against the inner surface of the cutting foil. Conventionally, the oscillating cutter is spring loaded in order to keep close surface contact with the cutting foil at all times during shaving passes. While this arrangement provides for a clean, close shave of relatively short hair stubble, the small perforations of the cutting foil present difficulties when attempting to shave longer hairs of more than a few days growth.

Rotary systems, on the other hand, yield a more effective shaving system for longer hairs. Typically, rotary systems include a plurality of disc cutters made of a robust material. The robust material, along with the geometry of the disc cutters, facilitates cutting longer hairs and provides a smooth shaving experience. The geometry of the disc cutters, however, limits the effectiveness of providing a clean, close shave as a result of a slight separation in the contact area between the hairs at the skin surface and the disc cutters. Moreover, the effectiveness is also limited due to the shaving pass patterns involved with rotary systems. Usually with rotary systems, for example, a user will shave with a circular motion as opposed to a generally linear motion as used with foil systems. The linear motion used with foil systems provides the user with a much more effective shave as the contact area between the hairs and the cutters is at a maximum.

As such, some foil system electric shavers have been designed to include an open trimmer in parallel with the cutting foil so that longer hair can be trimmed down to a shorter length before entering the cutting foil. While this arrangement benefits from the closer shave performance of the foil system, the open trimmer may potentially come into direct contact with the skin surface and cause nicking of the skin.

### SUMMARY

In accordance with an aspect of the disclosure, a cutter for an electric shaver is provided. The cutter may include an inner cutter having a plurality of inner cutter ribs. Each inner cutter rib may be orientated at a first angle. A frame may be coupled to the inner cutter. An outer cutter may be coupled to the frame and may include a comb portion. The comb portion may include a plurality of outer cutter ribs with each outer cutter rib including a first and second chamfer and a contour disposed therebetween. The contour may gradually slope inwardly from the first and second chamfer to a substantially flat central surface. Each outer cutter rib may be orientated at a second angle that correspondingly oppositely-faces the first angle. The plurality of inner cutter ribs is in operable engagement with the plurality of outer cutter ribs.

In accordance with another aspect of the disclosure, the contour of each outer cutter rib may include at least a first outer cutting edge and each inner cutter rib may include at least a first inner cutting edge.

In accordance with yet another aspect of the disclosure, the at least first outer cutting edge may have a first unit of hardness that differs from a second unit of hardness of the at least first inner cutting edge.

In accordance with still yet another aspect of the disclosure, the frame may include a first and second cutter clip and a channel disposed therebetween.

In further accordance with another aspect of the disclosure, the inner cutter may be joined to a carrier having opposing fingers. The opposing fingers may be in operable engagement with the channel.

In further accordance with yet another aspect of the disclosure, a first spring may be disposed adjacent to the first cutter clip and a second spring may be disposed adjacent to the second cutter clip. The first and second springs may be operably coupled to the carrier.

In further accordance with still yet another aspect of the disclosure, each of the outer cutter ribs may be equally spaced apart to form an outer cutter slot between adjacent outer cutter ribs.

In further accordance with an even further aspect of the disclosure, each outer cutter rib may have a first thickness proximate to each of the first and second chamfers and the substantially flat central surface may have a second thickness. The first thickness may be greater that the second thickness.

In accordance with another aspect of the disclosure, an electric shaver having an electric motor is provided. The electric shaver may include a head. At least a first foil cutter may be centrally disposed on the head so that the at least first foil cutter may have a first height relative to the head. At least a first and a second linear cutter may be disposed on the head. The at least first foil cutter may be disposed between the at least first and second linear cutters. Each of the at least first and second linear cutters may include an inner cutter having a plurality of inner cutter ribs, a frame operably coupled to the inner cutter, and an outer cutter coupled to the frame. The outer cutter may have a comb portion including a plurality of outer cutter ribs. Each of the outer cutter ribs may include a first and second chamfer and a contour disposed therebetween. The plurality of inner cutter ribs may be in operable engagement with the plurality of outer cutter ribs. Each of the at least first and second linear cutters may have a second height relative to the head. The first height always being greater than the second height.

In accordance with still another aspect of the disclosure, the contour of each outer cutter rib may be a flat surface slanting from the second chamfer to the first chamfer.

In further accordance with yet another aspect of the disclosure, each inner cutter rib may be orientated at a first angle and each outer cutter rib may be orientated at a second angle. The second angle may be correspondingly oppositely-facing the first angle.

In accordance with another aspect of the disclosure, a method of producing a self-sharpening linear cutter for use in an electric shaver is provided. The method entails forming an inner cutter having a plurality of inner cutter ribs so that each inner cutter rib is orientated at a first angle. Another step may be forming an outer cutter with a passage for operatively receiving the inner cutter. Yet another step may be forming a comb portion onto the outer cutter, the comb portion including a plurality of outer cutter ribs, each outer cutter rib including a first and a second chamfer and a contour being disposed therebetween, the contour gradually sloping inwardly from the first and second chamfer to a substantially flat central surface, each outer cutter rib being orientated at a second angle, the second angle correspondingly oppositely-facing the first angle. A further step may be orientating the plurality of inner cutter ribs to operably engage the plurality of outer cutter ribs.

In accordance with yet another aspect of the disclosure, the method may include forming the plurality of inner cutter ribs and the plurality of outer cutter ribs by a metal stamping process.

In accordance with still yet another aspect of the disclosure, the method may include forming the contour with at least a first cutting edge of stainless steel coated in titanium.

In accordance with still an even further aspect of the disclosure, the method may include forming the plurality of inner cutter ribs to have a first unit of hardness that differs from a second unit of hardness of the plurality of outer cutter ribs.

In further accordance with another aspect of the disclosure, the method may include forming each outer cutter rib to have a first thickness proximate to each of the first and second chamfers that is greater than a second thickness of the substantially flat central surface.

Other aspects and features of the disclosed systems and methods will be appreciated from reading the attached detailed description in conjunction with the included drawing figures. Moreover, selected aspects and features of one example embodiment may be combined with various selected aspects and features of other example embodiments.

### BRIEF DESCRIPTION OF THE DRAWINGS

For further understanding of the disclosed concepts and embodiments, reference may be made to the following detailed description, read in connection with the drawings, wherein like elements are numbered alike, and in which:

FIG. 1 is a perspective view of an electric shaver with portions sectioned and broken away to show details of the present disclosure;

FIG. 2 is a front view, in cross-section, of a shaving head with portions broken away to show details of the present disclosure;

FIG. 3 is a perspective view of a shaving head with portions sectioned and broken away to show details of the present disclosure;

FIG. 4 is another perspective view of a shaving head with portions sectioned and broken away to show details of the present disclosure;

FIG. 5 is an exploded view of a linear cutter, constructed in accordance with the teachings of this disclosure;

FIG. 6 is a cross-sectional view taken along line 6-6 of FIG. 5 of an outer cutter, constructed in accordance with the teachings of this disclosure;

FIG. 7 is a detailed view of outer cutter ribs as depicted in FIG. 6;

FIG. 8 is a cross-sectional view taken along line 8-8 of FIG. 5 of an outer cutter, constructed in accordance with the teachings of this disclosure;

FIG. 9 is a detailed perspective view of a shaving head, constructed in accordance with the teachings of this disclosure;

FIG. 10 is side view of a shaving head with portions sectioned and broken away to show the details of the present disclosure;

FIG. 11 is a perspective view depicting an alternative embodiment of an outer cutter with portions sectioned and broken away to show details of the present disclosure;

FIG. 12 is a flowchart illustrating a sample sequence of steps which may be practiced in accordance with the teachings of this disclosure; and

FIGS. 13-19 are top views depicting alternative embodiments of a comb portion of an outer cutter, constructed in accordance with the teachings of the present disclosure.

It is to be noted that the appended drawings illustrate only typical embodiments and are therefore not to be considered limiting with respect to the scope of the disclosure or claims. Rather, the concepts of the present disclosure may apply within other equally effective embodiments. Moreover, the drawings are not necessarily to scale, emphasis generally being placed upon illustrating the principles of certain embodiments.

### DETAILED DESCRIPTION

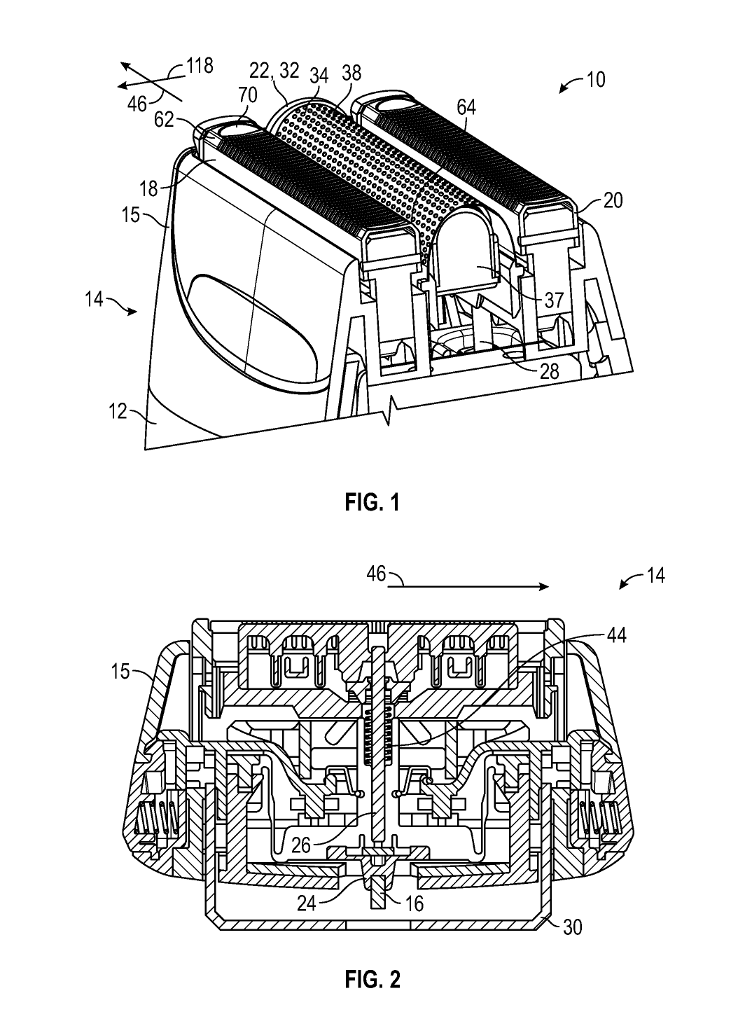

Referring now to FIGS. 1 and 2, an electric shaver constructed in accordance with the present disclosure is generally referred to by reference numeral 10. The electric shaver 10 includes a body 12 and a shaving head 14 disposed thereon. A protective casing 15 encases the shaving head 14. An electric motor (not shown) may be housed within the body 12 and may be in mechanical association with an eccentric pin 16. The shaving head 14 may include first and second self-sharpening linear cutters 18, 20 and a central foil cutter 22 disposed between the first and second linear cutters 18, 20. The shaving head 14 also includes an oscillating driver 24, which is driven by the eccentric pin 16. First and second driving pins 26, 28 are associated with the oscillating driver 24 to drive the cutters 18, 20, 22. In particular, the first driving pin 26 drives the first linear cutter 18 and the foil cutter 22 and the second driving pin 28 drives the second linear cutter 20. The second driving pin 28 may additionally drive other auxiliary cutter elements. The shaving head 14 may also include a swivel frame 30 affording the shaving head 14 swivel movement.

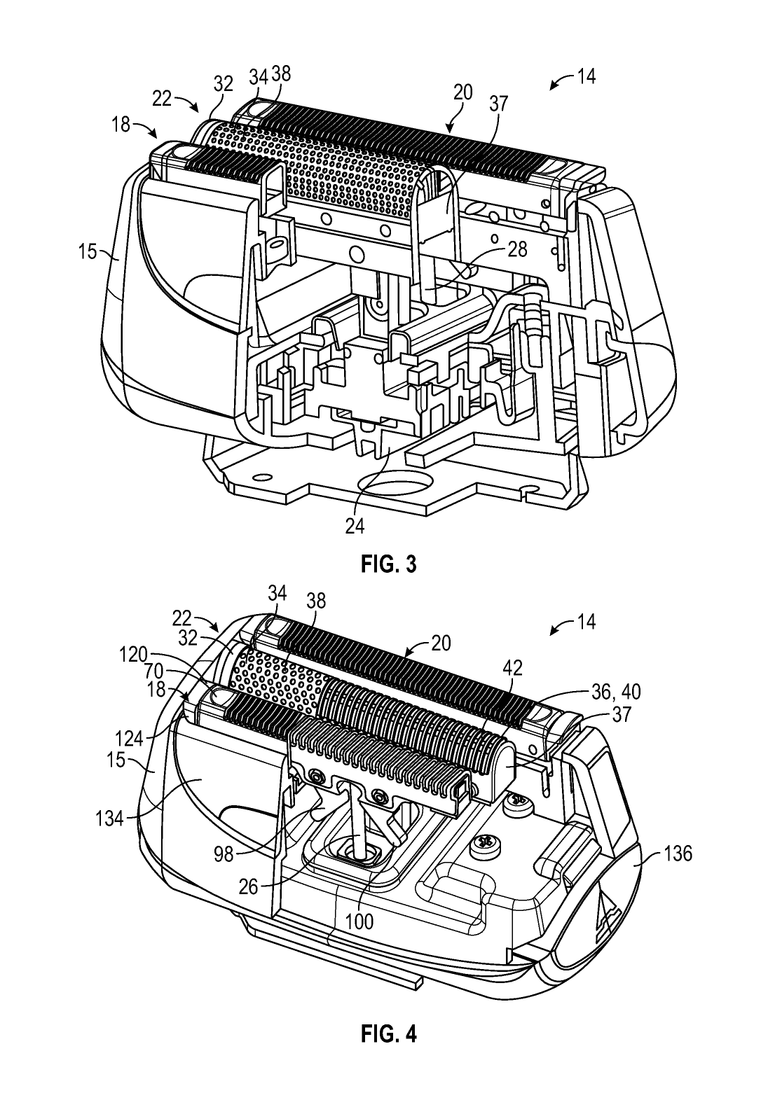

As best seen in the various views of FIGS. 1-4, the foil cutter 22 includes a foil frame 32, a cutting foil 34 and a foil inner cutter 36 disposed onto a foil inner cutter carrier 37. The cutting foil 34 is formed with a plurality of perforations 38 and is retained to the foil frame 32. The foil inner cutter 36 is formed of a plurality of foil cutter ribs 40, which may have, but not limited to, an arcuate shape. Each foil cutter rib 40 is equally spaced apart so that a slot 42, which may be arcuate in shape, is formed between adjacent foil cutter ribs 40. The cutting foil 34 mimics the shape of the plurality of foil cutter ribs 40 so that the cutter ribs 40 are urged into close surface contact, by a suspension spring 44, with the inner surface of the cutting foil 34. When the foil inner cutter 36 is driven by the first driving pin 26 the foil inner cutter 36 reciprocates along a longitudinal axis 46 and against the inner surface of the cutting foil 34.

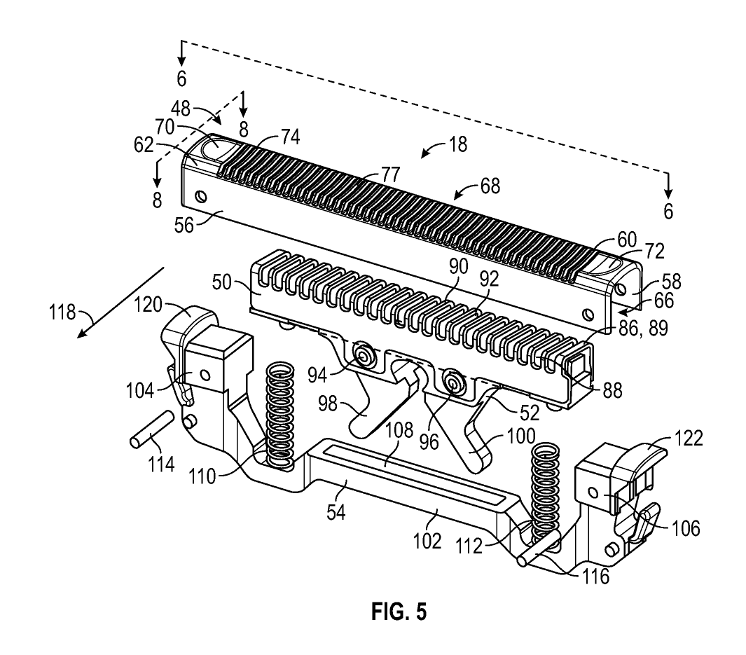

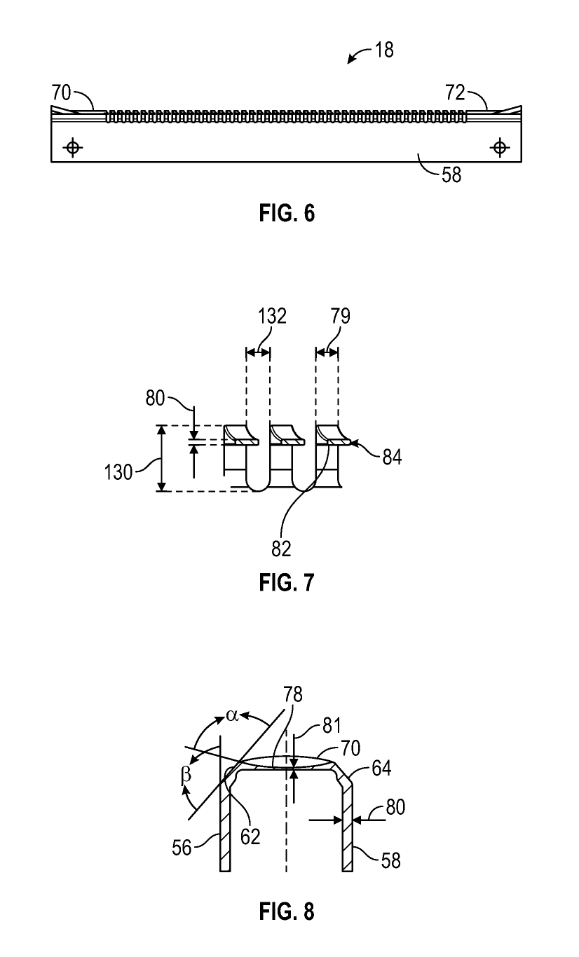

As the first and second self-sharpening linear cutters 18, 20 are identical in structure, only the first linear cutter 18 will be described with particular reference to FIGS. 5-8. The first linear cutter 18 includes an outer cutter 48, a linear inner cutter 50, a linear inner cutter carrier 52 and a linear inner cutter frame 54.

The outer cutter 48 includes first and second longitudinal walls 56, 58 with a working surface 60 disposed therebetween. The first longitudinal wall 56 includes a first chamfer 62, which joins the first longitudinal wall 56 to the working surface 60. Similarly, the second longitudinal wall 58 includes a second chamfer 64, which joins the second longitudinal wall 58 to the working surface 60 so that the walls 56, 58 and the working surface 60 collectively form a longitudinal passage 66.

A comb portion 68 is collectively formed of the first and second chamfers 62, 64 and the working surface 60 in an area between a first and second end section 70, 72 of the outer cutter 48. Furthermore, the comb portion 68 includes a plurality of outer cutter ribs 74. Each outer cutter rib 74 is equally spaced apart so that an outer cutter slot 76 is formed between adjacent outer cutter ribs 74. Each outer cutter rib 74, between the first and second chamfers 62, 64, may have a contour 77, which gradually slopes inwardly from each chamfer 62, 64 toward the longitudinal passage 66 where it plateaus to a substantially flat central surface 78 . It should be noted that contour 77 may have other profiles, as will be discussed in more detail below.

With particular reference to FIGS. 7 and 8, each cutter rib 74 may have a width 79 to thickness 80 ratio in a range between 4:1 to 5:1. In particular, each cutter rib 74 may be thicker where the chamfers 62, 64 meet the contour 77 and may be thinner at the substantially flat central surface 78. The flat central surface 78 has a thickness 81 that is not greater than 0.08 mm. The contour 77 of each cutter rib 74 includes a first and second cutting edge 82, 84 facing inwardly toward the longitudinal passage 66. Moreover, the thicker area, where the chamfers 62, 64 meet the contour 77, ensures that a user's skin does not get nicked by the first and second cutting edges 82, 84.

Referring back to FIG. 5, the linear inner cutter 50 includes a plurality of inner cutter ribs 86. Each inner cutter rib 86 is equally spaced apart so that an inner cutter slot 88 is formed between adjacent inner cutter ribs 86. Each inner cutter rib 86 includes a flat cutting surface 89 having oppositely-facing first and second cutting edges 90, 92. The linear inner cutter 50 may be joined to the linear inner cutter carrier 52 with a first and second heat melt rivet 94, 96 or other techniques known in the industry. The linear inner cutter carrier 52 also includes opposing fingers 98, 100, which are engaged with the linear inner cutter frame 54.

The linear inner cutter frame 54 includes a base 102 disposed between a first and second cutter clip 104, 106. The base 102 includes a channel 108, which receives the opposing fingers 98, 100 of the linear inner cutter carrier 52. A first spring 110 extends from the base 102 adjacent to the first cutter clip 104 and a second spring 112 extends from the base 102 adjacent to the second cutter clip 106.

When the first linear cutter 18 is fully assembled the outer cutter 48 is joined to the first and second cutter clips 104, 106 of the linear inner cutter frame 54 by corresponding first and second lock pins 114, 116, respectively, so that the linear inner cutter 50 operatively fits within the longitudinal passage 66 and is urged into close surface contact with the outer cutter 48 by the even force of the first and second springs 110, 112 against the linear inner cutter carrier 52.

Moreover, the first and second cutting edges 82, 84 of the outer cutter 48 are arranged to slant oppositely to the first and second cutting edges 90, 92 of the linear inner cutter 50 such that, during operation, the cutting edges 82, 84, 90, 92 operate like scissors. In particular, the first and second cutting edges 82, 84 may be at a slant angle between 5 and 30 degrees from an axis 118 perpendicular to the longitudinal axis 46 and the first and second cutting edges 90, 92 may be at a corresponding oppositely-facing slant angle between 5 and 30 degrees. A pitch ratio between the outer cutter 48 and the linear inner cutter 50 may be approximately 2.5 to 3. The cutting edges 82, 84, 90, 92 may be hardened to over 56 ob [please define this unit of measure decribed in your disclosure claim 9]. The first and second cutting edges 82, 84 may be of a different hardness, greater than 56 ob, than the first and second cutting edges 90, 92 so that, during operation, the cutting edges 82, 84 self-sharpen the cutting edges 90, 92, and vice versa. Furthermore, the first and second cutting edges 82, 84 of the outer cutter 48 may be, but not limited to, stainless steel, which may be coated with, but not limited to, titanium or diamond-like carbon.

During operation of the electric shaver 10, the first and second driving pins 26, 28 are driven in oppositely reciprocating directions, with respect to the longitudinal axis 46, from each other. As such, the first driving pin 26 causes the foil inner cutter 36 to reciprocate against the cutting foil 34, while at the same time causes the linear inner cutter carrier 52 of the first linear cutter 18 to reciprocate in the same direction so that the plurality of inner cutter ribs 86 reciprocates and engages in a shearing motion with the plurality of outer cutter ribs 74, which are stationary with respect to the longitudinal axis 46. The second linear cutter 20 operates similarly to the first linear cutter 18 except its linear inner cutter carrier reciprocates in a motion exactly opposite in direction. As an example of a shaving pass of the electric shaver 10 glided against a user's face, longer hairs may be guided through the first chamfer 62 of the comb portion 68 so that the longer hairs pass the flat central surface 78 and are sheared off by the reciprocating motion of the plurality of inner cutter ribs 86 engaging with the plurality of outer cutter ribs 74. Next, the trimmed hairs are guided through the second chamfer 64 of the comb portion 68, transferred into the plurality of perforations 38 of the cutting foil 34 of the central foil cutter 22, and are cleanly and closely sheared off due to the reciprocating motion of the plurality of foil cutter ribs 40 against the inner surface of the cutting foil 34. A second shaving pass in the opposite direction operates in a similar fashion expect the longer hairs enter the second linear cutter 20 instead of the first linear cutter 18.

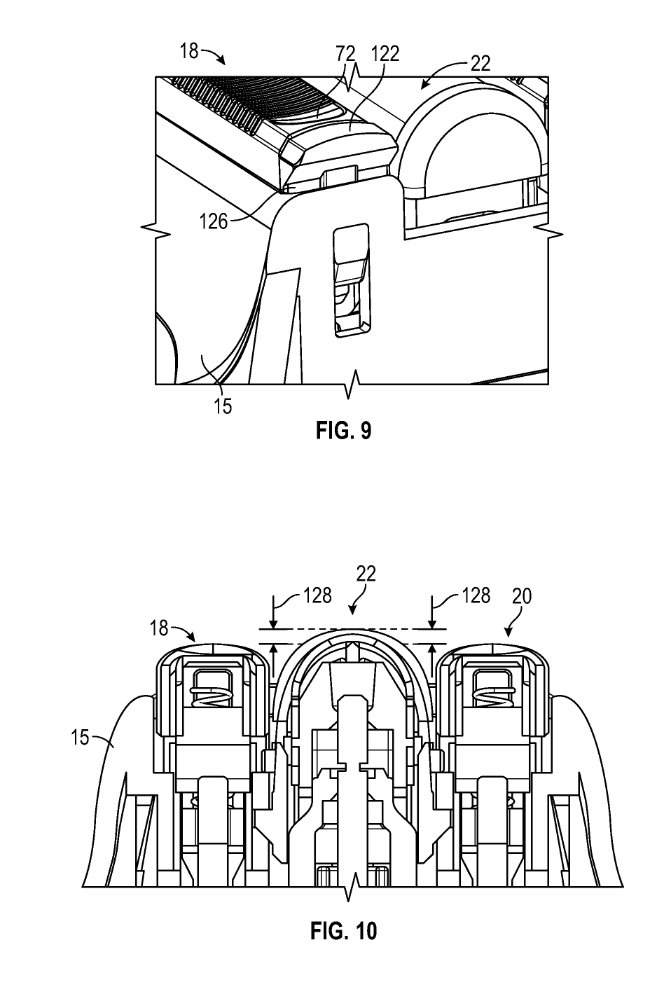

With reference to FIGS. 4-5 and 9, first and second guidance stops 120, 122 are disposed adjacent to the first and second cutter clips 104, 106, respectively. First and second minor clearance gaps 124, 126 are located between the first and second guidance stops 120, 122, respectively, and the casing 15. As the electric shaver 10 is glided against a user's face, the minor clearance gaps 124, 126 allow the first linear cutter 18 to tilt, with respect to the casing 15, up to the point where either of the first and second guidance stops 120, 122 rests on the casing 15 and prevents the first linear cutter 18 from tilting further. The tilt angle of the first linear cutter 18 may be approximately three degrees in either direction. This also applies to the second linear cutter 20, as it is identical in structure to the first linear cutter 18.

As best seen in FIG. 10, the central foil cutter 22 is positioned so that at all times it always extends further outwardly than either the first or second linear cutters 18, 20 as illustrated by the height differential 128 between the foil cutter 22 and both the first and second linear cutters 18, 20. Although the shaving head 14 has been described to include a first and second self-sharpening linear cutter 18, 20 and a central foil cutter 22 disposed between the first and second linear cutters 18, 20, it should be noted that this arrangement is only exemplary and the shaving head 14 may include any number and combination of linear cutters and foil cutters. As a non-limiting alternative example, a shaving head may include a first and second linear cutter with a first and second foil cutter both disposed between the linear cutters.

It is shown in FIG. 7 that each outer cutter slot 76 includes a depth 130 and a width 132. The depth 130 may be in the approximate range of 1.1 mm to 2 mm. The width 132 may be approximately 0.38 mm or less. Furthermore, as shown in FIG. 8, the chamfers 62, 64 include a first angle α and a second angle β. The first angle α is measured approximately between a line tangential to the surface of the first chamfer 62 and a line tangential to the meeting area of the first chamfer 62 and the working surface 60. The first angle α may be approximately greater than 90 degrees and preferably approximately 112.65 degrees. The second angle β is measured approximately between the line tangential to the surface of the first chamfer 62 and a perpendicular line tangential to the surface of the first longitudinal wall 56. The second angle β may be approximately greater than 90 degrees and preferably approximately 144.5 degrees.

As best seen in FIG. 4, the casing 15 may include a detachable hair pocket 134 that may be operatively released from the casing 15 via a release button 136.

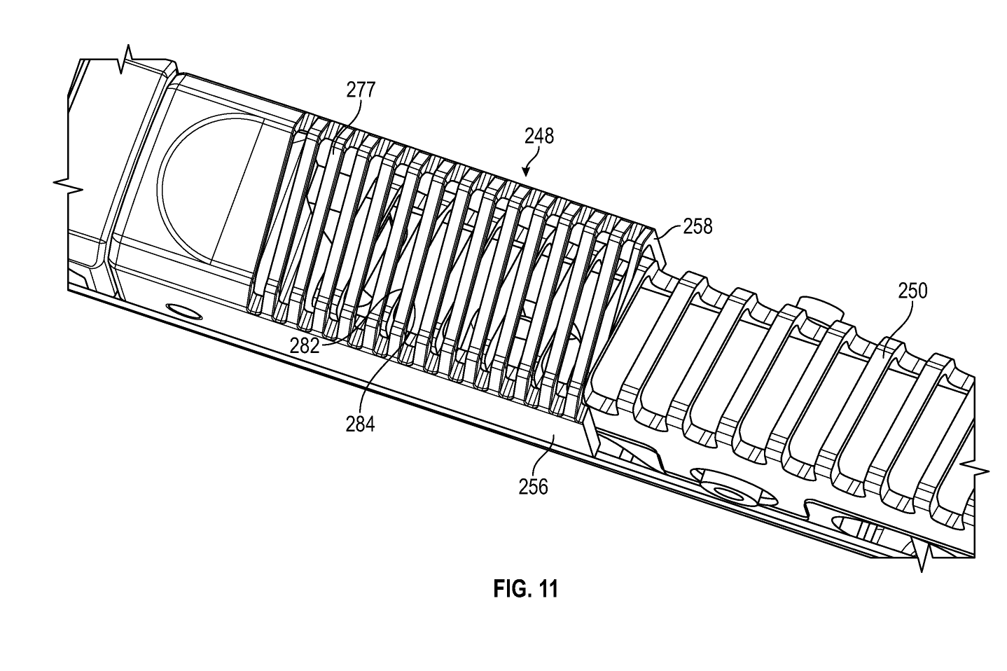

FIG. 11 illustrates an example alternative embodiment outer cutter 248, which is similar to the first outer cutter 48 except the contour 277 profile of each rib of the plurality of outer cutter ribs 274 differs from the contour 77 profile of the first outer cutter 48. As shown, the contour 277 has a flat surface and is slanted from the second longitudinal wall 258 towards the first longitudinal wall 256. Similarly, the contour 277 includes a first and second cutting edge 282, 284 facing inwardly toward the longitudinal passage 266 and similarly engages with the linear inner cutter 250. It should been understood that profiles other than described for contours 77, 277 may fall within the scope of the appended claims.

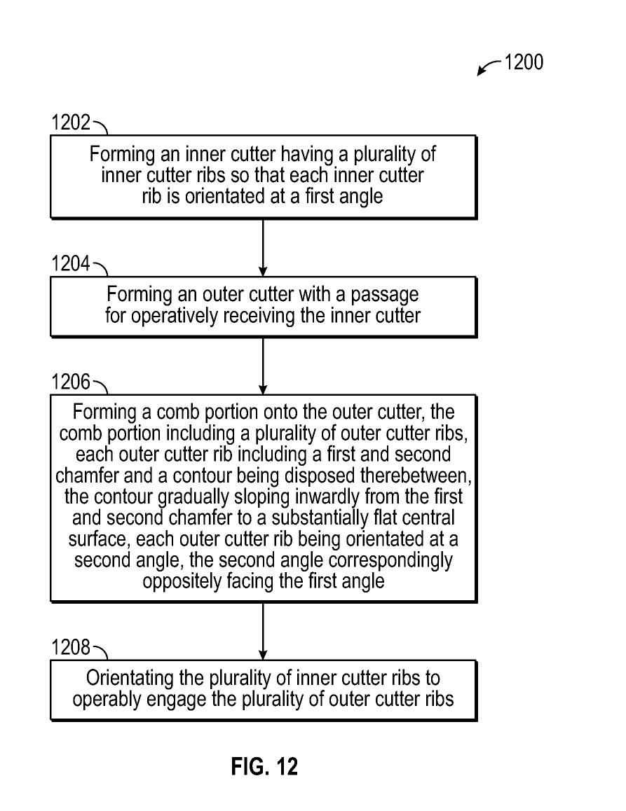

FIG. 12 illustrates a flow chart 1200 of a sample sequence of steps which may be performed to a self-sharpening linear cutter for use in an electric shaver. Box 1202 shows the step of forming an inner cutter having a plurality of inner cutter ribs so that each inner cutter rib is orientated at a first angle. Another step, as illustrated in box 1204, is forming an outer cutter with a passage for operatively receiving the inner cutter. Box 1206 illustrates the step of forming a comb portion onto the outer cutter, the comb portion including a plurality of outer cutter ribs, each outer cutter rib including a first and second chamfer and a contour being disposed therebetween, the contour gradually sloping inwardly from the first and second chamfer and plateauing into a substantially flat central surface, each outer cutter rib being orientated at a second angle, the second angle correspondingly oppositely-facing the first angle. Yet another step, as illustrated in box 1208, is orientating the plurality of inner cutter ribs to be in operable engagement with the plurality of outer cutter ribs. The plurality of inner cutter ribs and the plurality of outer cutter ribs may be formed by a metal stamping process. The contour may be formed with at least a first cutting edge of stainless steel coated in titanium. The plurality of inner cutter ribs may be formed to have a first unit of hardness that differs from a second unit of hardness of the plurality of outer cutter ribs. Each outer cutter rib may be formed to have a first thickness proximate to each of the first and second chamfers that is greater than a second thickness of the substantially flat central surface.

Referring now to FIGS. 13-19, various example alternative embodiments of an outer cutter are illustrated. Each of the alternative embodiments is similar to the first outer cutter 48 except the comb portion of each embodiment differs from the comb portion 68 of the first outer cutter 48. With reference to the outer cutter 1348 of FIG. 13, the comb portion 1368 may be formed of, moving from the first end section 1370 to the second end section 1372, first through ninth comb arrays 1381-1389. The first, fifth and ninth comb arrays 1381, 1385, 1389 may be formed of ribs that are serrated on both sides. The second, fourth, sixth and eighth comb arrays 1382, 1384, 1386, 1388 may be formed of ribs that have linear sides. The third and seventh comb arrays 1383, 1387 may be formed of first array ribs 1390 bowing toward the first end section 1370 and second array ribs 1392 bowing toward the second end section 1372. The first and second array ribs 1390, 1392 are arranged so that a hollow 1394 is disposed therebetween.

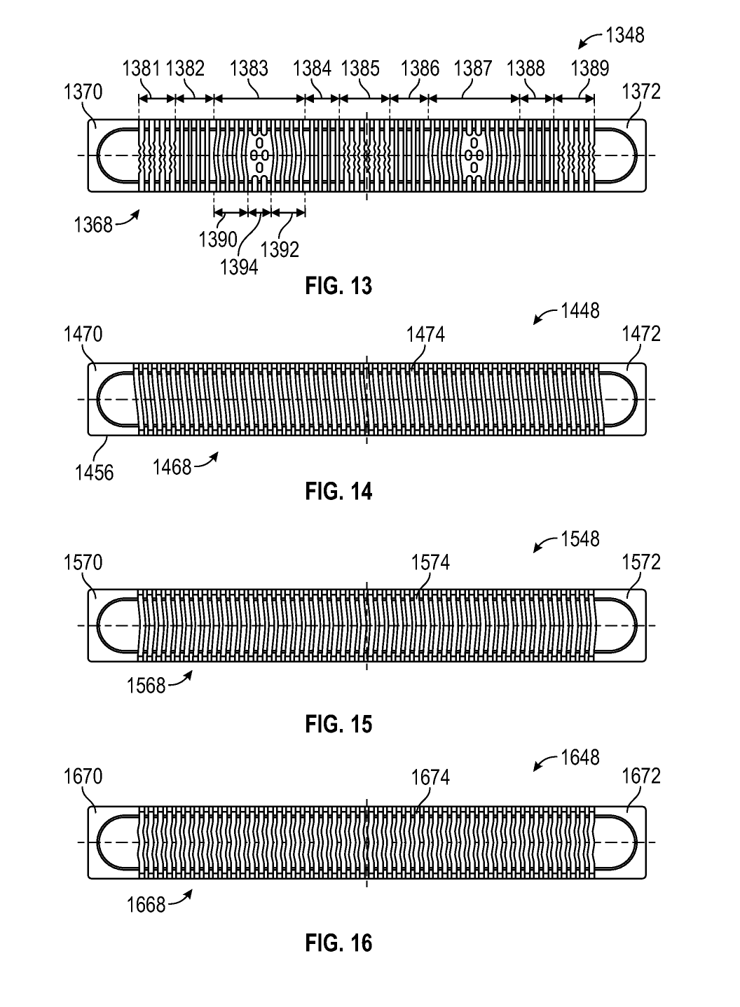

Referring to the outer cutter 1448 illustrated in FIG. 14, the comb portion 1468 may be formed of ribs 1474 having linear sides that non-orthogonal relative to the wall 1456.

Referring to the outer cutter 1548 illustrated in FIG. 15, the comb portion 1568 may be formed of chevron-shaped ribs 1574.

Referring to the outer cutter 1648 illustrated in FIG. 16, the comb portion 1668 may be formed of rippled ribs 1674.

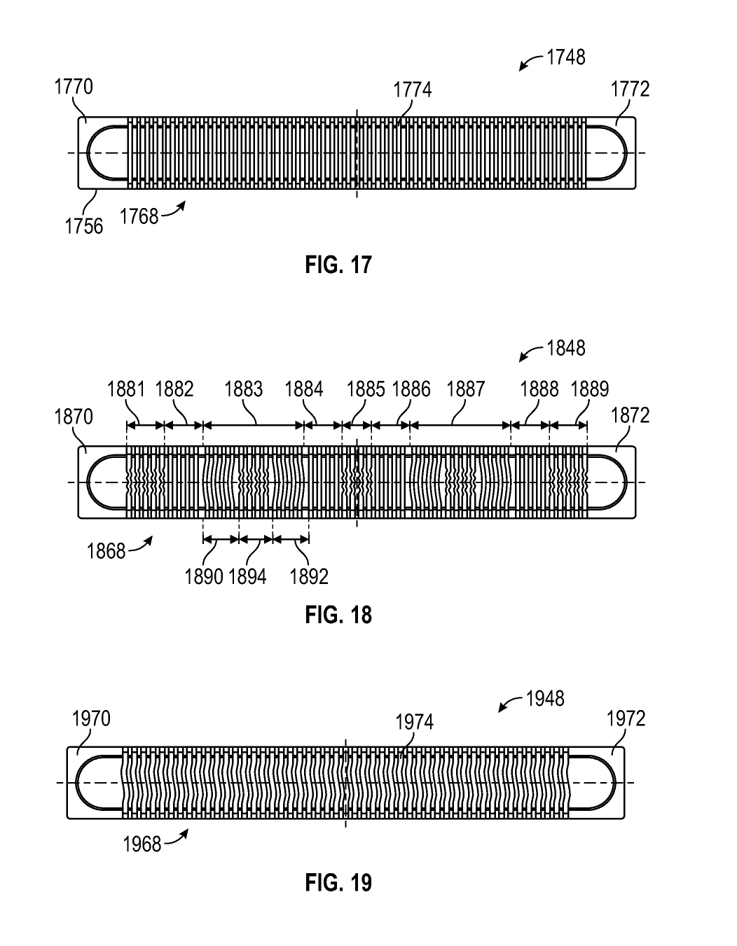

Referring to the outer cutter 1748 illustrated in FIG. 17, the comb portion 1768 may be formed of ribs 1774 having linear sides that are orthogonal relative to wall 1756.

Referring to the outer cutter 1848 illustrated in FIG. 18, the comb portion 1868 may be formed of, moving from the first end section 1870 to the second end section 1872, first through ninth comb arrays 1881-1889. The first, fifth and ninth comb arrays 1881, 1885, 1889 may be formed of ribs that are serrated on both sides. The second, fourth, sixth and eighth comb arrays 1882, 1884, 1886, 1888 may be formed of ribs that have linear sides. The third and seventh comb arrays 1883, 1887 may be formed of first array ribs 1890 bowing toward the first end section 1870 and second array ribs 1892 bowing toward the second end section 1872. The first and second array ribs 1890, 1892 are arranged so that serrated ribs 1894 are disposed therebetween.

Referring to the outer cutter 1948 illustrated in FIG. 19, the comb portion 1968 may be formed of herringbone-shaped ribs 1974.

While the present disclosure has shown and described details of exemplary embodiments, it will be understood by one skilled in the art that various changes in detail may be effected therein without departing from the spirit and scope of the disclosure as defined by claims supported by the written description and drawings. Further, where these exemplary embodiments (and other related derivations) are described with reference to a certain number of elements it will be understood that other exemplary embodiments may be practiced utilizing either less than or more than the certain number of elements.

### INDUSTRIAL APPLICABILITY

Based on the foregoing, it can be seen that the present disclosure sets forth a linear cutter for an electric shaver. The teachings of this disclosure can be employed to trim relatively long while eliminating the potential of nicking the skin. Moreover, through the novel teachings set forth above, the linear cutter self-sharpens its multiple cutting edges affording a longer life span to the linear cutter.

What is claimed is:

1. A cutter for an electric shaver, the cutter comprising:
an inner cutter having a plurality of inner cutter ribs, each inner cutter rib being orientated at a first angle;
a frame coupled to the inner cutter; and
an outer cutter coupled to the frame, the outer cutter having a comb portion, the comb portion including a plurality of outer cutter ribs, each outer cutter rib including a first and second chamfer and a contour being disposed therebetween, the contour gradually sloping inwardly from the first and second chamfer to a substantially flat central surface, each outer cutter rib being orientated at a second angle, the second angle correspondingly oppositely-facing the first angle, the plurality of inner cutter ribs being in operable engagement with the plurality of outer cutter ribs.

2. The cutter of claim 1, wherein the contour of each outer cutter rib includes at least a first outer cutting edge and each inner cutter rib includes at least a first inner cutting edge.

3. The cutter of claim 2, wherein the at least first outer cutting edge has a first unit of hardness that differs from a second unit of hardness of the at least first inner cutting edge.

4. The cutter of claim 1, wherein the frame further includes a first and a second cutter clip and a channel disposed therebetween.

5. The cutter of claim 4, wherein the inner cutter is joined to a carrier having opposing fingers, the opposing fingers being in operable engagement with the channel.

6. The cutter of claim 5, further including a first spring disposed adjacent to the first cutter clip and a second spring disposed adjacent to the second cutter clip, the first and second springs being operably coupled to the carrier.

7. The cutter of claim 1, wherein each of the outer cutter ribs is equally spaced apart to form an outer cutter slot between adjacent outer cutter ribs.

8. The cutter of claim 1, wherein each outer cutter rib has a first thickness proximate to each of the first and second chamfers and the substantially flat central surface has a second thickness, the first thickness being greater than the second thickness.

9. An electric shaver having an electric motor, the shaver comprising:
a head;
at least a first foil cutter being centrally disposed on the head, the at least first foil cutter having a first height relative to the head;
at least a first and a second linear cutter being disposed on the head, the at least first foil cutter being disposed between the at least first and second linear cutters, each of the at least first and second linear cutters including an inner cutter having a plurality of inner cutter ribs, a frame operably coupled to the inner cutter, and an outer cutter coupled to the frame, the outer cutter having a comb portion, the comb portion including a plurality of outer cutter ribs, each outer cutter rib including a first and second chamfer and a contour being disposed therebetween, the plurality of inner cutter ribs being in operable engagement with the plurality of outer cutter ribs, each of the at least first and second linear cutters having a second height relative to the head, the first height always being greater than the second height.

10. The shaver of claim 9, wherein the contour of each outer cutter rib gradually slopes inwardly from the first and second chamfer to a substantially flat central surface.

11. The shaver of claim 10, wherein the contour of each outer cutter rib includes at least a first outer cutting edge and each inner cutter rib includes at least a first inner cutting edge.

12. The shaver of claim 11, wherein the at least first outer cutting edge has a first unit of hardness that differs from a second unit of hardness of the at least first inner cutting edge.

13. The shaver of claim 9, wherein each inner cutter rib is orientated at a first angle and each outer cutter rib is orientated at a second angle, the second angle correspondingly oppositely-facing the first angle.

14. The shaver of claim 9, wherein each outer cutter rib has a first thickness proximate to each of the first and second chamfers and the substantially flat central surface has a second thickness, the first thickness being greater than the second thickness.

15. The shaver of claim 9, wherein the contour of each outer cutter rib is a flat surface slanting from the second chamfer to the first chamfer.

16. A method of producing a self-sharpening linear cutter for use in an electric shaver, the method comprising:
forming an inner cutter having a plurality of inner cutter ribs, each inner cutter rib orientated at a first angle;
forming an outer cutter with a passage for operatively receiving the inner cutter;
forming a comb portion onto the outer cutter, the comb portion including a plurality of outer cutter ribs, each outer cutter rib including a first and a second chamfer and a contour being disposed therebetween, the contour gradually sloping inwardly from the first and second chamfer to a substantially flat central surface, each outer cutter rib being orientated at a second angle, the second angle correspondingly oppositely-facing the first angle; and
orientating the plurality of inner cutter ribs to operably engage the plurality of outer cutter ribs.

17. The method of claim 16, further including forming the plurality of inner cutter ribs and the plurality of outer cutter ribs by a metal stamping process.

18. The method of claim 16, further including forming the contour with at least a first cutting edge of stainless steel coated in titanium.

19. The method of claim 16, further including forming the plurality of inner cutter ribs to have a first unit of hardness that differs from a second unit of hardness of the plurality of outer cutter ribs.

20. The method of claim 16, further including forming each outer cutter rib to have a first thickness proximate to each of the first and second chamfers that is greater than a second thickness of the substantially flat central surface.
